(19) United States
(12) Patent Application Publication
(10) Pub. No.: US 2017/0014824 A1
(43) Pub. Date: Jan. 19, 2017

(54) APPARATUS AND METHOD FOR SORTING OF CELLS

(71) Applicants: Lawrence M. Boyd, Durham, NC (US); John J. Ratcliffe, JR., Raleigh, NC (US); Andres Jose Garcia, Atlanta, GA (US); Todd Christopher McDevitt, Atlanta, GA (US)

(72) Inventors: Lawrence M. Boyd, Durham, NC (US); John J. Ratcliffe, JR., Raleigh, NC (US); Andres Jose Garcia, Atlanta, GA (US); Todd Christopher McDevitt, Atlanta, GA (US)

(21) Appl. No.: 15/211,565

(22) Filed: Jul. 15, 2016

Related U.S. Application Data
(60) Provisional application No. 62/193,834, filed on Jul. 17, 2015.

(51) Int. Cl. B01L 3/00

(52) U.S. Cl. CPC B01L 3/502761; B01L 2200/0652; B01L 2200/025; B01L 2300/0867; B01L 2400/0478; B01L 2200/0689

(57) ABSTRACT

A device for use in sorting cells comprises a first body member having a pair of longitudinally spaced through passages opening to a inner surface. A second body member has an inner surface and a portion defining an opening. The first body member is configured to be mounted to the second body member such that a gasket is disposed between the inner surface of the first body member. The substrate is disposed between the gasket and the inner surface of the second body member for overlying the opening in the second body member. The openings in the first body member open onto an inner surface of the substrate at opposite ends of a channel defined by the inner surface of the first body member, an elongated longitudinal opening in the gasket and the substrate.

### CROSS-REFERENCE

This application is related to U.S. provisional application No. 62/193,834, filed Jul. 17, 2015, entitled “FLOW BASED CELL SORTING APPARATUS AND METHOD”, naming Lawrence M. Boyd, John J. Ratcliffe, Jr., Andres Jose Garcia and Scott Christopher McDevitt as the inventors. The contents of the provisional application are incorporated herein by reference in their entirety, and the benefit of the filing date of the provisional application is hereby claimed for all purposes that are legally served by such claim for the benefit of the filing date.

### BACKGROUND

An apparatus and method for sorting of cells is described and, more particularly, an apparatus and method that relates generally to cell sorting based on cell adhesion force and uses microfluidics for delivering a fluid shear stress.

Sorting of cells is used for deriving a purified cell population from a heterogeneous cell population. Current methods for sorting cells are based upon physical parameters of the cells, such as size or density. More commonly, cell sorting methods are based on affinity—chemical, electrical, or a magnetic coupling. However, such cell sorting methods are usually only suitable for a research lab environment with highly trained research assistants and students. The methods are time consuming, inefficient, and highly dependent on the technical proficiency of the technician. Moreover, the current methods often do not result in a homogenous cell population (low purity) and may introduce variability and raise potential safety concerns.

An alternative method is cell sorting based on adhesive force of two or more cell populations using fluid shear stress via a microfluidic system. This method represents a label-free separation technique, requires minimal cell processing or exposure to electrical or magnetic separation fields, and can be employed to detach cells in their native microenvironment. Adhesive force-based cell sorting is particularly advantageous for isolating stem cells and cells derived therefrom. Stem cells have characteristic adhesive signatures that can be exploited to isolate such cells from each other and from other cells adhered to a substrate in culture.

A methodology for adhesive force-based stem cell sorting is described in U.S. Patent Application Publication No. 2014/0357506, entitled “Adhesive Signature-Based Methods for the Isolation of Stem Cells and Cells Derived Therefrom”, filed Mar. 28, 2014, the contents of which are hereby incorporated by reference in their entirety. The methodology focuses in particular on human induced pluripotent stem cells (hiPSCs), and exploits differences in the adhesion strength of the cells to allow the user to selectively isolate and enrich hiPSCs from heterogeneous populations of cells using microfluidics. This technique has created a need to develop high-throughput adhesive-based technologies that can efficiently separate target cells and colonies of target cells from contaminating cells.

For the foregoing reasons, there is a need for a new apparatus and method for sorting cells and addressing the limitations of the current technology. The new apparatus and method should facilitate efficient and rapid sorting of cells for research in a laboratory and for high-volume commercial applications.

### SUMMARY

A device for use in sorting cells is provided, the cell sorting device comprising a first body member having an inner surface and pair of longitudinally spaced through passages opening to the inner surface, a second body member having an inner surface, a portion of the second body member defining an opening, a substrate having an inner surface, and a gasket defining an elongated longitudinal opening. The first body member is configured to be mounted to the second body member such that the gasket is disposed between the inner surface of the first body member and the substrate, and the substrate is disposed between the gasket and the inner surface of the second body member for overlying the opening in the second body member. The openings in the first body member open onto the inner surface of the substrate at opposite ends of a channel defined by the inner surface of the first body member, the gasket and the substrate.

In one aspect, the substrate is transparent.

In another aspect, the portion of the second body member defining the opening has a continuous ledge for receiving and supporting the substrate such that the inner surface of the substrate is flush with the inner surface of the second body member. In this embodiment, the gasket spaces the inner surface of the first body member from the inner surface of the second body member.

In a further aspect, each of the first body member and the second body member comprises a base portion terminating in edges, and the cell sorting device further comprises a continuous peripheral wall depending from the edges of the base portion of one of the first body member or the second body member and terminating in longitudinal edges. A flange is integral with and extends along at least a portion of an edge of the depending wall. The other of the first body member or the second body member defines a slot along an edge. The slot is configured to receive the flange for a snap-fit connecting the first body member and the second body member. The flange is configured for contacting the other of the first body member and the second body member when connecting for flexing the flange of the first body member resiliently outwardly or resiliently inwardly for changing the outer dimensions of the wall such that the slot defined by the other of the first body member or the second body member receives the terminal edges of the flange.

In one aspect, the terminal edges of the flange of the body portion of one of the first body member or the second body member engage the inner surface of the slot of the other of the first body member or the second body member. In another aspect, the terminal edges of the flange of the body portion of one of the first body member or the second body member engage the outer surface of the slot of the other of the first body member or the second body member. In both aspects, the distance from the longitudinal edges of the base portion to the longitudinal edges of the wall is less than the width of the gasket.

In yet another aspect, each body member comprises a base portion terminating in longitudinal edges, and further comprising legs extending from the longitudinal edges of the base portion of one the first body member or the second body member and terminating in longitudinal edges such that the base portion and the legs define an open longitudinal channel configured to slidably receive the other of the first body member or the second body member.

The cell sorting device may further comprise a flange integral with and extending along at least a portion of the longitudinal edges of each leg, wherein the other of the first body member or the second body member defines a slot along an edge, the slot configured to receive the flanges for a snap-fit connecting the first body member and the second body member. The flanges may be configured for contacting the other of the first body member or the second body member when connecting for flexing the legs of the first body member or the second body member resiliently outwardly or resiliently inwardly for changing the outer dimensions of the legs such that the slot defined by the other of the first body member or the second body member receives the terminal edges of the flanges. In one embodiment, the terminal edges of the flanges of the body portion of one of the first body member or the second body member engage the inner surface of the slot of the other of the first body member or the second body member. In another embodiment, the terminal edges of the flanges of the body portion of one of the first body member or the second body member engage the outer surface of the slot of the other of the first body member or the second body member. The distance from the longitudinal edges of the base portion to the longitudinal edges of the legs may be less than the width of the gasket.

In yet another aspect, the each body member comprises a base portion terminating in longitudinal edges, and the cell sorting device further comprises legs extending from the longitudinal edges of the base portion of one of the first body member or the second body member and terminating in longitudinal edges. The base portion and the legs define an open longitudinal channel. A flange is integral with the longitudinal edges of each leg, the flanges extending inwardly such that the base portion, legs, and flanges define opposed longitudinal slots, wherein the longitudinal channel and slots are configured to slidably receive the other of the first body member or the second body member.

Another feature comprises fluid transfer fittings configured to be disposed in the openings in the first body member for communication with a fluid source or fluid capture apparatus.

In another embodiment, the first body member is pivotally connected to the second body member for movement between an open position and a closed position where the first body member and the second body member are connected.

Another device for use for sorting cells is provided, the cell sorting device comprising a body member having an inner surface defining a cavity, the first body member having a first end and a second end and holes at each of the first and second ends opening into the cavity. A block member has an outer surface defining a longitudinally extending open channel. The block member is configured to be disposed in the body member such that the first and second holes align with the ends of the channel and the substrate is disposed between the inner surface of the body member and the block member.

In one aspect, a portion of the body member defining the cavity has an opening, wherein the substrate overlies the opening in the body member. The portion of the body member defining the opening may have a continuous ledge for receiving and supporting the substrate such that the inner surface of the substrate is flush with the inner surface of the body member.

In a further aspect, wherein the channel in the block member opens onto the surface of the substrate.

Still another device for use in sorting cells is provided. The cell sorting device comprises a first body member having an inner surface, a second body member having an inner surface defining a cavity, the second body member having a first end and a second end and holes at each of the first and second ends opening into the cavity, and a block member having a longitudinally extending channel. The first body member is configured to be mounted to the second body member such that the block member is disposed in the cavity between the inner surface of the first body member and the inner surface of a substrate. The substrate is disposed between the block member and the inner surface of the second body member. The block member is configured to be disposed in the cavity such that the first and second holes align with the ends of the channel.

In one aspect, a portion of the second body member defining the cavity has an opening, wherein the substrate overlies the opening in the body member.

In another aspect, the portion of the body member defining the opening has a continuous ledge for receiving and supporting the substrate.

### BRIEF DESCRIPTION OF THE DRAWINGS

For a more complete understanding of the cell sorting apparatus and method, reference should now be had to the embodiments shown in the accompanying drawings and described below. In the drawings:

FIG. 1 is a top perspective view of an embodiment of an apparatus for cell sorting.

FIG. 2 is an exploded top perspective view of the cell sorting apparatus as shown in FIG. 1.

FIG. 3 is longitudinal cross-section and transverse cross-section views of the cell sorting apparatus as shown in FIG. 1.

FIG. 4 is an up-close longitudinal cross-section view of an inlet end of the cell sorting apparatus as shown in FIG. 3.

FIG. 5 is an up-close transverse cross-section view of a portion of the cell sorting apparatus as shown in FIG. 1.

FIG. 6 is a top perspective view of a second embodiment of an apparatus for cell sorting.

FIG. 7 is an exploded top perspective, a longitudinal cross-section and transverse cross-section views of the cell sorting apparatus as shown in FIG. 6.

FIG. 8 is top perspective view of a plurality of stacked cell sorting apparatus as shown in FIG. 6.

FIG. 9 is a top perspective view of a third embodiment of a cell sorting apparatus for adhesive stem cell sorting.

FIG. 10 is an exploded top perspective, a longitudinal cross-section and transverse cross-section views of the cell sorting apparatus for adhesive stem cell sorting as shown in FIG. 9.

FIG. 11A is a top perspective view of a fourth embodiment of a cell sorting apparatus.

FIG. 11B is a top perspective view of the cell sorting apparatus as shown in FIG. 11A in a first open position.

FIG. 12 is a top perspective view of a fifth embodiment of a cell sorting apparatus.

FIG. 13 is an exploded top perspective view of the cell sorting apparatus as shown in FIG. 12.

FIG. 14 is a top perspective view of a sixth embodiment of a cell sorting apparatus.

FIG. 15 is an exploded top perspective, a longitudinal cross-section and transverse cross-section views of the cell sorting apparatus as shown in FIG. 14.

FIG. 16A is a top plan view of the cell sorting apparatus as shown in FIG. 14.

FIG. 16B is a bottom plan view of the cell sorting apparatus as shown in FIG. 14.

FIGS. 17A-17D are perspective views of cartridge inserts for use with a cell sorting apparatus.

FIG. 18 is a top perspective view of a seventh embodiment of a cell sorting apparatus.

FIG. 19 is a petri dish for use in the cell sorting apparatus as shown in FIG. 18

FIG. 20 is an exploded top perspective view of the cell sorting apparatus as shown in FIG. 18.

FIG. 21 is a top exploded perspective view of an eight embodiment of a cell sorting apparatus.

FIG. 22 is a transverse cross-section view of the cell sorting apparatus as shown in FIG. 21.

FIG. 23 is a top plan view of a ninth embodiment of a cell sorting apparatus.

FIG. 24 is an exploded transverse cross-section view of the cell sorting apparatus as shown in FIG. 23.

FIG. 25 is a transverse cross-section view of the cell sorting apparatus as shown in FIG. 23.

FIG. 26 is a transverse cross-section of a tenth embodiment of cell sorting apparatus.

FIG. 27 is a perspective view of the cell sorting apparatus as shown in FIG. 26.

FIG. 28 is a partially cut-away top plan view of an eleventh embodiment of a cell sorting apparatus.

FIG. 29 is a transverse cross-section view of the cell sorting apparatus as shown in FIG. 28.

FIG. 30 is an up-close transverse cross-section view of a top plate for use with a cell sorting apparatus.

FIG. 31 is a top exploded perspective view of a twelfth embodiment of a cell sorting apparatus.

FIG. 32 is a transverse cross-section view of the cell sorting apparatus as shown in FIG. 31.

### DESCRIPTION

Certain terminology is used herein for convenience only and is not to be taken as a limiting. For example, words such as “upper,” “lower,” “left,” “right,” “horizontal,” “vertical,” “upward,” “downward,” “top” and “bottom” merely describe the configurations shown in the Figures. Indeed, the components may be oriented in any direction and the terminology, therefore, should be understood as encompassing such variations unless specified otherwise. The words “interior” and “exterior” refer to directions toward and away from, respectively, the geometric center of the core and designated parts thereof. The terminology includes the words specifically mentioned above, derivatives thereof and words of similar import.

As used herein, “axial” is deemed to mean parallel to an axis of an apparatus or device, but not necessarily coaxial therewith.

As used herein, “cell” means any cell or cells, as well as viruses or any other particles having a microscopic size, e.g. a size that is similar to that of a biological cell, and includes any prokaryotic or eukaryotic cell, e.g., bacteria, fungi, plant and animal cells. Cells are typically spherical, but can also be elongated, flattened, deformable and asymmetrical, i.e., non-spherical. The size or diameter of a cell typically ranges from about 0.1 to 120 microns, and typically is from about 1 to 50 microns. A cell may be living or dead. Since the apparatus is directed to sorting materials having a size similar to a biological cell (e.g. about 0.1 to 120 microns) any material having a size similar to a biological cell can be characterized and sorted using the sorting apparatus.

As used herein, the term “flow” means any movement of liquid or solid through an apparatus or in a method of sorting, and encompasses without limitation any fluid stream, and any material moving with, within or against the stream, whether or not the material is carried by the stream. For example, the movement of cells through an apparatus or in a method, for example through channels of a cassette, comprises a flow. This is so, according to the method, whether or not the cells are carried by a stream of fluid also comprising a flow, or whether the cells are caused to move by some other direct or indirect force or motivation, and whether or not the nature of any motivating force is known or understood. The application of any force may be used to provide a flow, including without limitation, pressure, capillary action, electro-osmosis, electrophoresis, dielectrophoresis, optical tweezers, and combinations thereof, without regard for any particular theory or mechanism of action, so long as cells are directed for sorting according to the flow.

An apparatus and a method for sorting of cells is described and may be implemented in the setting of a lab or in a commercial environment. The apparatus and method utilize differences in the adhesion strength of certain cells as compared with other cells to selectively isolate cell types of interest using a hydrodynamic detachment force. The apparatus comprises a cassette which provides for easy loading of cells into a self-contained flow chamber, which ensures a sterile environment for cell detachment and recovery. Application of fluid flow through the flow chamber of the cassette generates fluid shear stresses on the adherent cells and colonies. The cassette may be configured to also allow direct and continuous visualization of the detachment process.

A characteristic “adhesive signature” associated with cells, such as stem cells and stem cell derivatives, can be used to selectively detach and isolate these cells from each other or from other cells in a mixture of cells adhered to a substrate based on differences in adhesion strength. A cell of interest can be isolated from a mixture of cells adhered to a substrate if there is a sufficient difference, higher or lower, in the adhesion strength of the cells of interest to the substrate relative to at least one other cell type present in the mixture of cells. A detachment force can be applied that will selectively detach the cell of interest from the substrate as compared with the at least one other cell type in the mixture of cells adhered to the substrate.

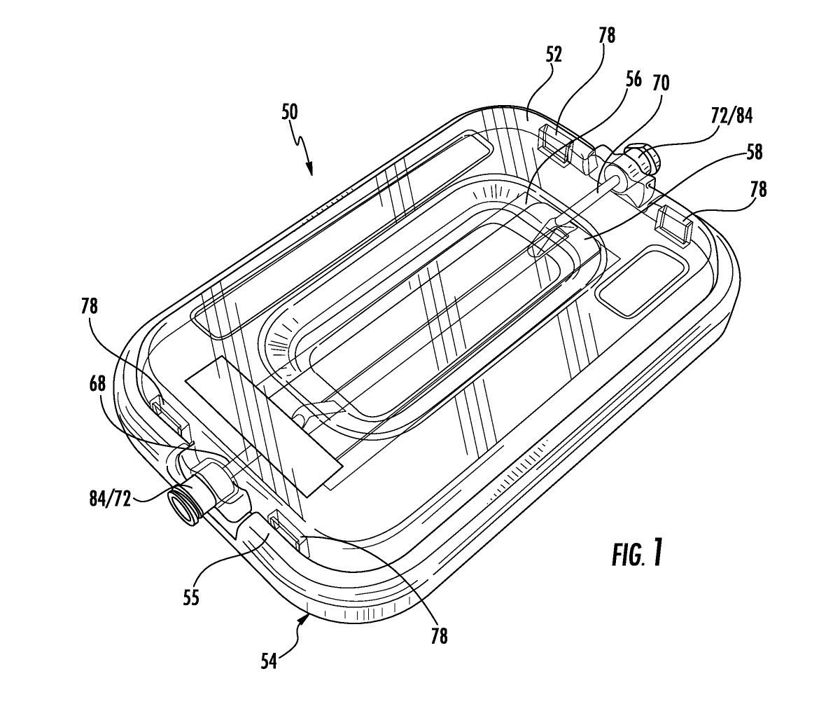

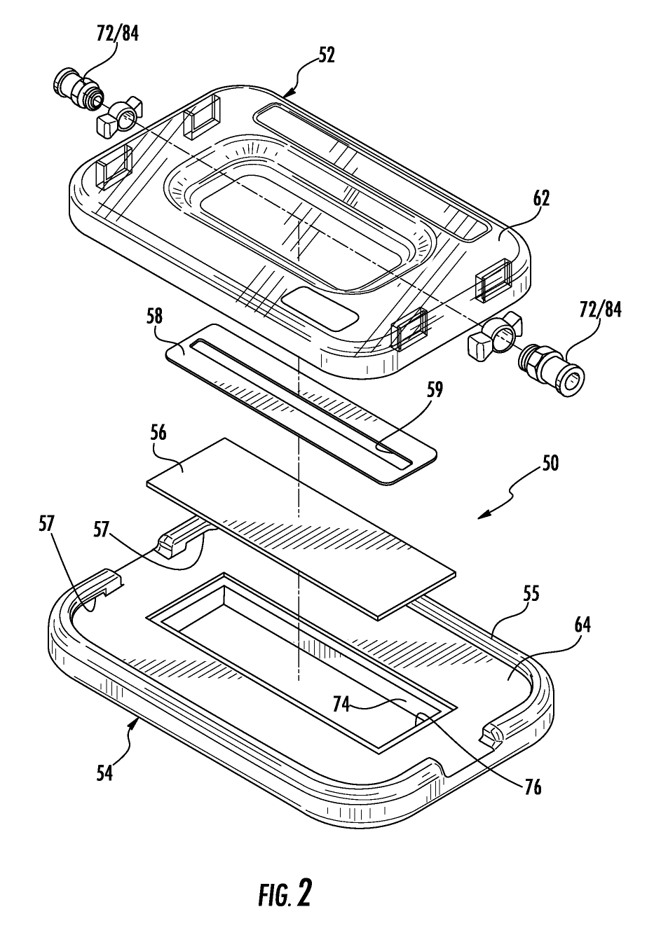

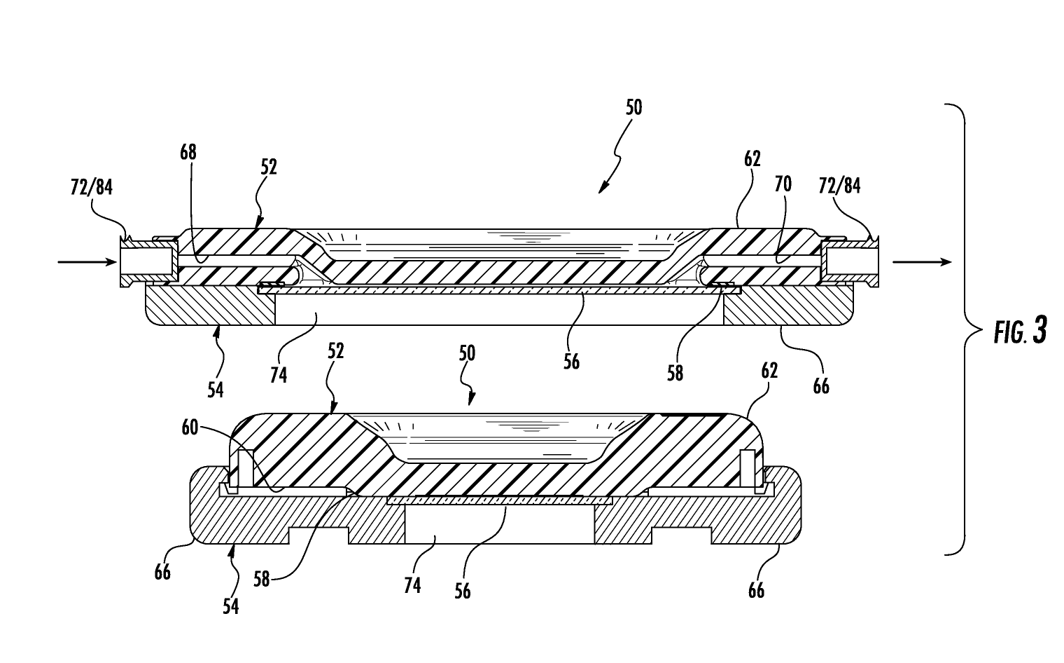

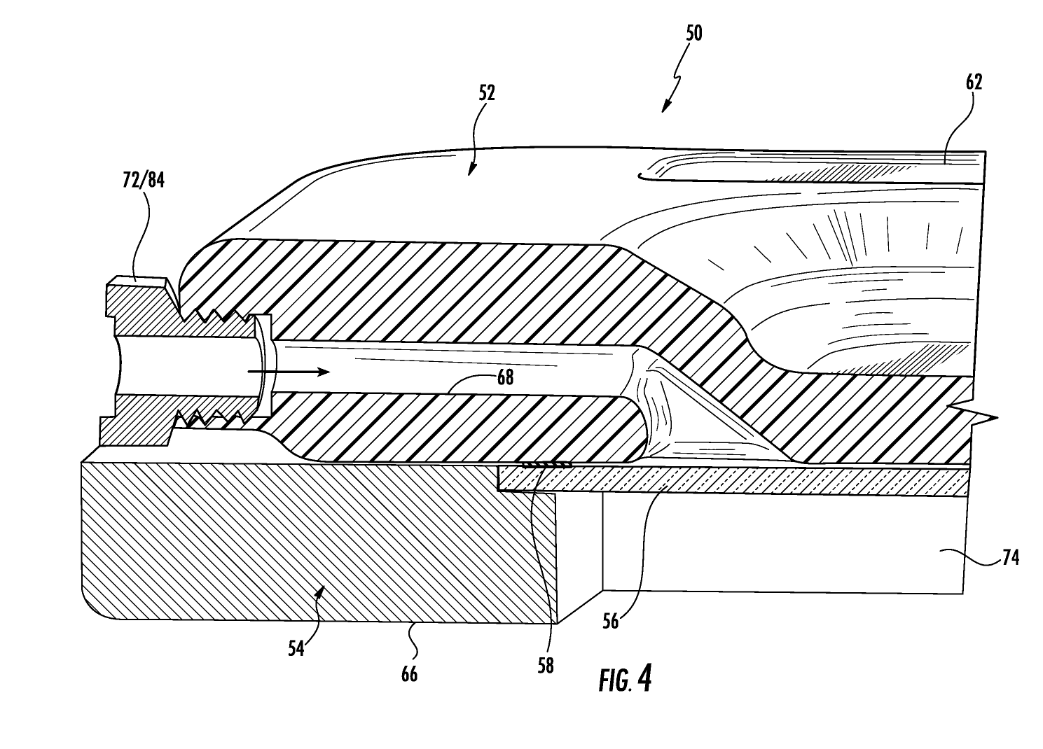

Referring now to the drawings, wherein like reference numerals indicate the same or similar elements throughout the several views, an embodiment of an apparatus for sorting cells is shown in FIGS. 1-5 and generally designated at 50. The cell sorting apparatus 50 comprises a cassette, including top cassette member 52, a bottom cassette member 54, a transparent substrate 56 and a gasket 58. The top cassette member 52 and the bottom cassette member 54 are generally rectangular and each have an inner surface 60, 64 and an outer surface 62, 66. Each end of the top cassette member 52 defines a central axial bore 68, 70 opening onto the inner surface 60 of the top cassette member 52. Each of the bores 68, 70 is internally threaded for receiving a luer fitting 72. As best shown in FIGS. 2 and 5, a peripheral wall 55 extends inwardly from the inner surface 64 of the bottom cassette member 54. The wall 55 defines a transverse slot 57 with the inner surface 64 of bottom cassette member 54 for forming a lip 82.

The top cassette member 52 and the bottom cassette member 54 may be formed from a number of acceptable materials, including plastics and metals. A cassette formed of plastic is bendable and resilient to a certain extent and thus insures that the portions can be readily assembled and snapped together, and separated from, one another. In one embodiment, the cassette portions are made of thermoformed, extruded or molded plastic resins. One suitable example of such a resin is styrene resin. In the embodiment shown, at least the top cassette member 52 of the cassette 50 is substantially clear or translucent allowing the visualization of the flow chamber and material held in the flow chamber for verification of cell adhesion and detachment at the targeted flow rates. It is understood that the scope of the invention is not intended to be limited by the materials listed here, but may be carried out using any material which allows the construction and operation of the sorting apparatus described herein.

The substrate 56 may be a conventional glass or plastic microscope slide. The bottom cassette member 54 defines a rectangular opening 74 corresponding to the size of the slide 56. The portion of the inner surface 64 of the bottom cassette member 54 defining the opening 74 includes a continuous ledge 76. The ledge 76 is configured to receive the slide 56 such that the surface of the slide is flush with the inner surface 64 of the bottom cassette member 54 forming a floor for the interior flow chamber. This configuration provides a window into the flow chamber of the cassette 50 so that the flow chamber can be optically observed through the bottom cassette member 54. In one embodiment, the slide 56 may be bonded to the ledge 76.

The top cassette member 52 and the bottom cassette member 54 of the cell sorting apparatus 50 are configured to be selectively joined together with the gasket 58 between forming the cassette. For this purpose, a plurality of engaging clips 78 project inwardly from the inner surface 60 of the top cassette member 52. The clips 78 are provided with tabs 80 extending orthogonally transversely from the distal ends of the clips 78. The tabs 80 are adapted to be received in the slot 57 defined by the peripheral wall 55 with the bottom cassette member 54. The clips 78 are preferably at least slightly resiliently deflectable, which resilience may be easily achieved by proper proportioning of their thickness relative to the projecting distance. It is understood that although the embodiments of the cassette shown herein depict a plurality of panel engaging clips 78, a single clip may also be selected.

Assembling the cassette 50 begins with bringing the clips 78 of the top cassette member 52 adjacent to the peripheral wall 55 of the bottom cassette member 54. The clips 78 are interlocked with the wall 55 of the bottom cassette member 54 by manually urging the tabs 80 into the slot 57. The clips 78 may be deformable, meaning they may bend or otherwise be altered in shape, to allow the tabs 80 to fit past the wall 55 and into the slot 57. The clips 78 are also resilient, meaning they will resist deformation and substantially return to their original shape when outside forces are no longer being applied. During insertion, the wall 55 of the bottom cassette member 54 defining the slot 57 will engage the tabs 80 and the clips will bend slightly inwardly due to manual pressure toward the bottom cassette member 54. Since the clips 78 are resilient, they will resist being compressed inwardly and will, upon the tabs 80 clearing the wall 55, resiliently press outwardly on the wall and the tabs 80 into the slot 57. The tabs 80 engage the lip 82 that defines the slot 57 for securing together the top cassette member 52 and the bottom cassette member 54 (FIG. 5).

With the top cassette member 52 and the bottom cassette member 54 secured together, the gasket 58 is compressed between the inner surface 60 of the top cassette member 52 and the slide 56. The length of the clips 78 and the position of the tabs 80 provides for control of the compressive force on the gasket 58. A central axial opening 59 in the gasket 58 creates a defined flow channel. The axial openings in the ends of the top cassette member 52 provide an inlet opening 68 and an outlet opening 70 for introducing and discharging a fluid into and from the channel, such as saline or tissue culture media. The Luer fittings 72 may be provided to attach tubing from the cassette 50 device to a pump (not shown), such as a precision syringe pump.

In use, fluid flow across cultured cells at a specified rate generates a target shear stress needed to either remove or retain the target cells. The shear stress exerted upon the cells can be precisely controlled by the width, height and length of the channel formed by the inner surface 60 of the top cassette member 52 surface, the gasket 58, and the surface of the slide 56 to which the cells are adhered. An inverted microscope (not shown) may be used, with the objective lens at the bottom and a light source at the top. The cassette 50 is configured such that it will easily fit on a microscope stage. The clear or translucent construction of the top cassette member 52 and the opening in the bottom cassette member 54 allow the user to easily visualize the condition of the cells cultured in the flow chamber during cell proliferation and at the time of the fluid shear.

To disassemble the cassette 50, the clips 78 are manually compressed inwardly sufficiently to disengage the tabs 80 from the slot 57 in the wall 55 of the bottom cassette member 54 and allow the tabs 80 to slide past the wall 55. The top cassette member 52 is then pulled away from the bottom cassette member 54 as the tabs 90 slide past the wall 55.

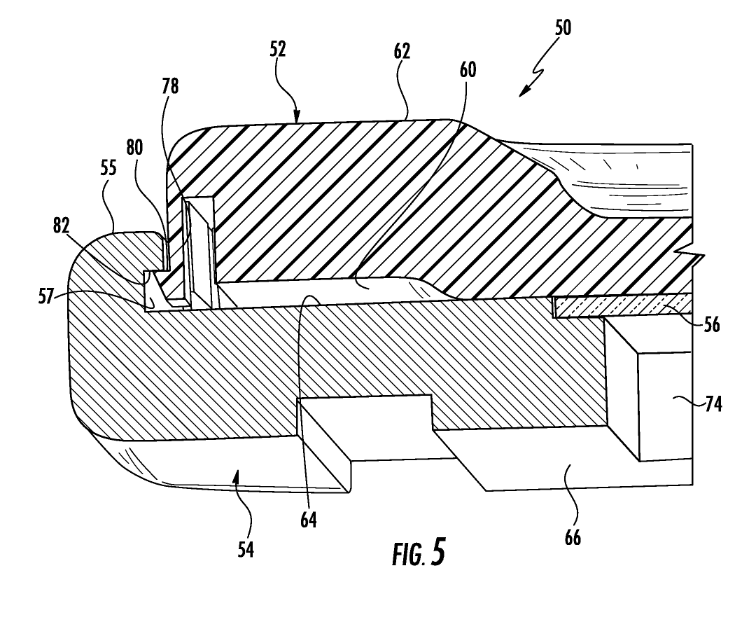

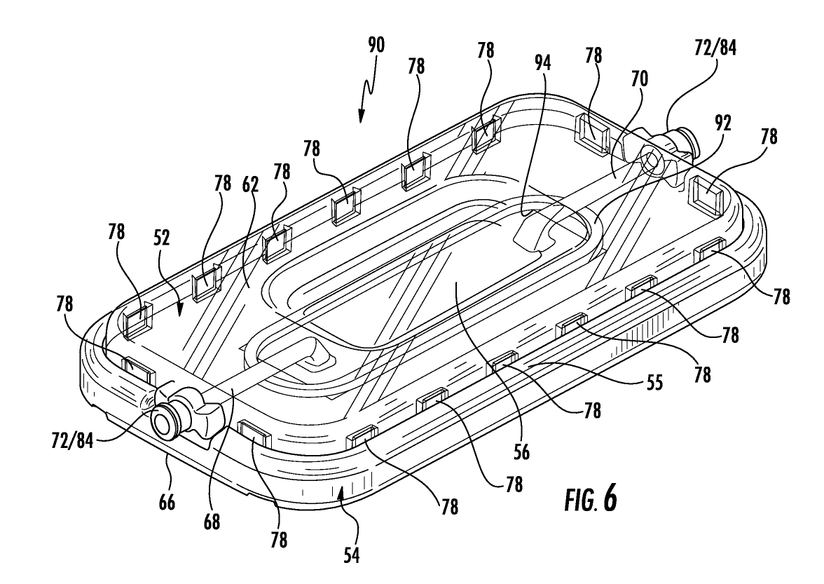

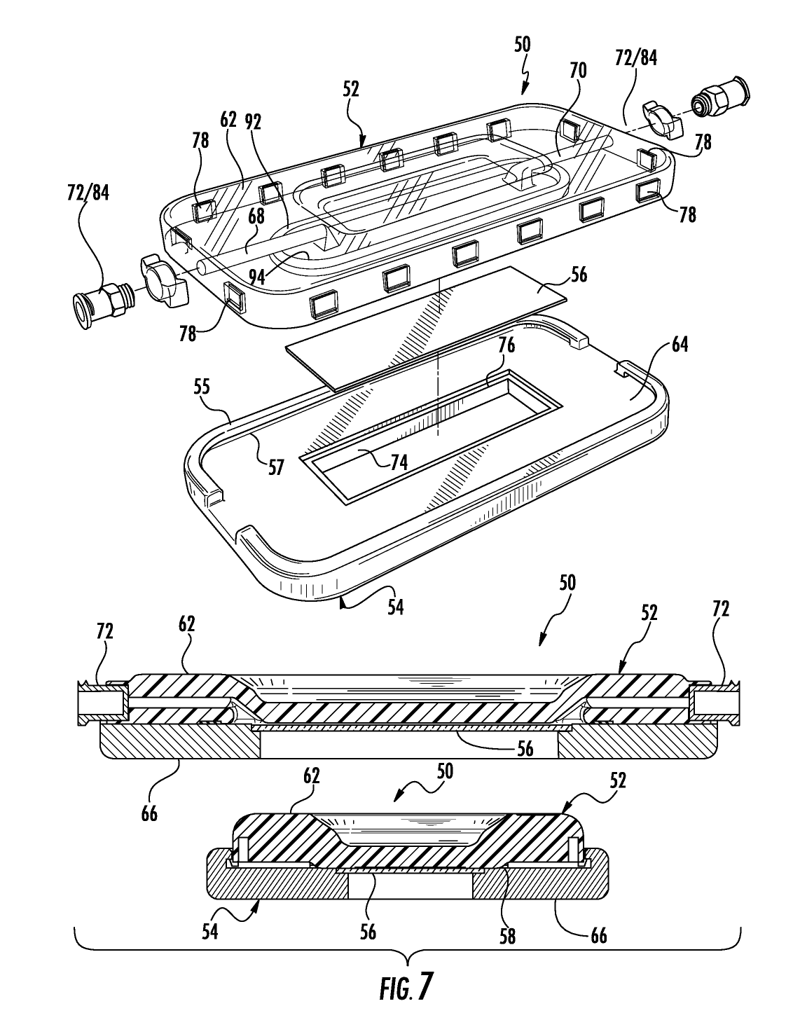

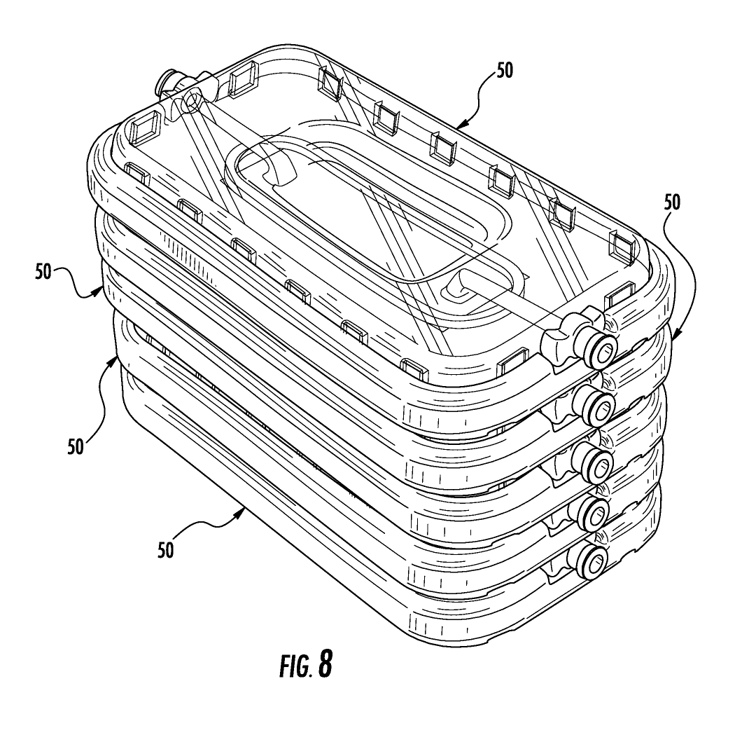

A second embodiment of an apparatus for sorting cells is shown in FIGS. 6-8 and generally designated at 90. The cell sorting apparatus 90 is substantially similar to the first embodiment described hereinabove. The parts of the second embodiment of the sorting apparatus which are identical to those of the sorting apparatus according to the above embodiment are denoted by identical reference numbers and will not be described in detail below. In this embodiment, an elongated ovular ring gasket 92 having an elongated ovular opening 94 is provided. The opening 94 in the gasket 92 creates a broader flow channel for the flow chamber. The configuration of the flow channel alters the shear stress exerted upon the cells to either remove or retain the target cells. As shown in FIG. 8, embodiments of the cell sorting cassettes 50, 90 allow for efficient stacking of the cassettes.

A third embodiment of an apparatus for sorting cells is shown in FIGS. 9-13 and generally designated at 100. The third embodiment of the cell sorting apparatus 100 is substantially similar to the first and second embodiments described hereinabove. The parts of the third embodiment of the sorting apparatus which are identical to those of the sorting apparatus according to the above embodiments are denoted by identical reference numbers and will not be described in detail below. In this embodiment 100, the gaskets 58, 92 of the previous embodiments are replaced by a substantially solid rectangular block 102 having a top surface 103 and a bottom surface 105. The bottom surface 105 of the block 102 defines at least one longitudinal groove 104 extending the length of the block 102. The block 102 may be formed from a silicone elastomer and the groove 104 may be formed by soft lithography techniques or injection molding of the silicone or another suitable elastomer.

The peripheral wall 55 at each end of the bottom cassette member 52 defines a central axial through bore 106, 108. The bores 106, 108 are internally threaded for receiving luer fittings 72. The bores 106, 108 open into the ends of the groove 104 in the block 102. The bottom cassette member 54 defines a rectangular opening 110 corresponding to the size of the block 102. The portion of the inner surface 64 of the bottom cassette member 54 defining the opening 110 includes a first continuous ledge 112. The ledge 112 is configured to receive the block 102 such that the surface of the block is flush with the inner surface 64 of the bottom cassette member 54. Spaced outwardly from the first continuous ledge 112 is a second continuous ledge 114 for receiving and supporting the slide 56. The first and second ledges 112, 114 are configured such that the groove 104 forms a top wall and side walls of a flow channel and the slide forms a bottom wall for the flow channel.

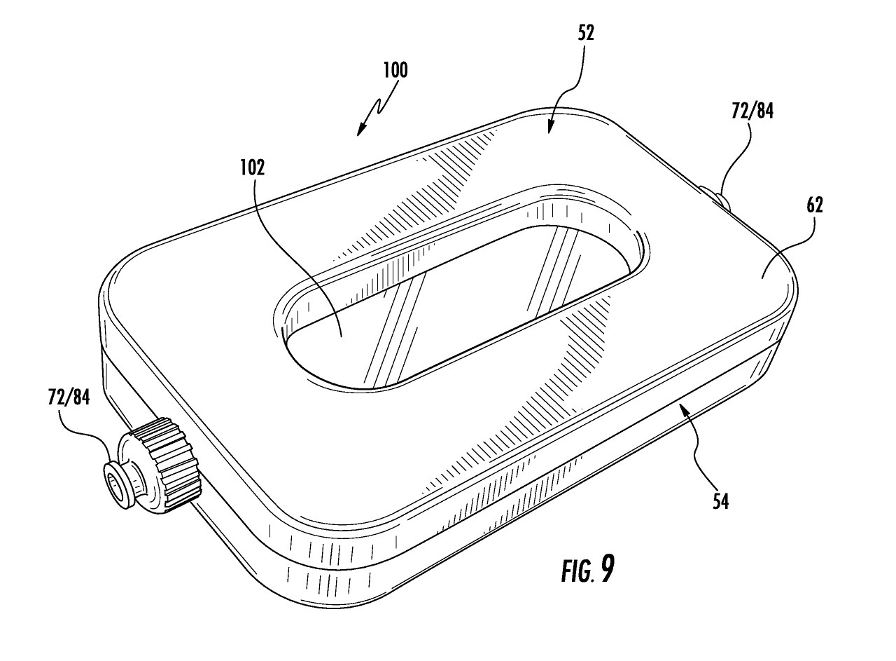

FIGS. 9 and 10 show a snap-together “clamshell” arrangement to secure the elastomer block 102 between the top cassette member 52 and the bottom cassette member 54 and against the slide 56 onto which the cells are cultured. Alternatively, as shown in FIGS. 11A and 11B, the top cassette member 52 may be pivotally mounted to the bottom cassette member 54 via a hinge assembly along one side for pivotal movement between a first open position and a second closed position. The elastomer block 102 is compressed against the slide in the closed position (FIG. 11A). The top cassette member 52 is sized so that, in the closed position, the top cassette member 52 substantially covers the inner surface 64 of the bottom cassette member 54. With the top cassette member 52 in the open position (FIG. 11B), the inner surface 64 of the bottom cassette member 54 is exposed and accessible to the user.

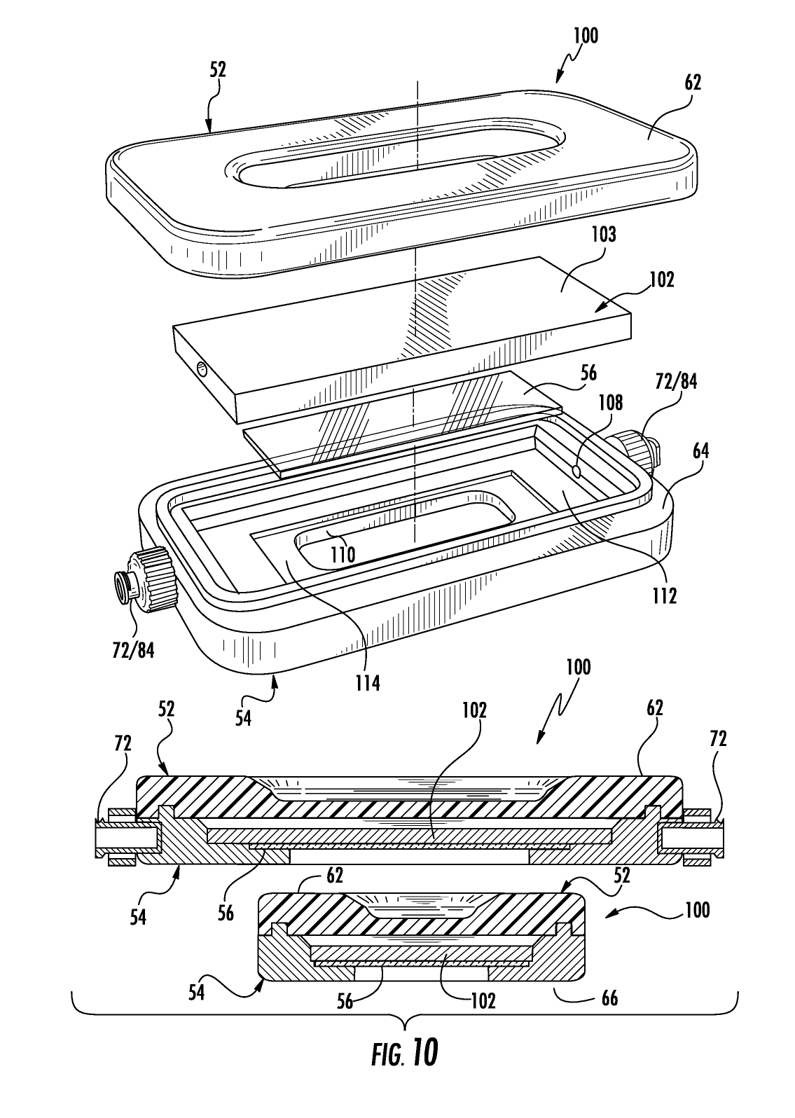

Referring to FIGS. 12 and 13, in another alternative of this embodiment the top cassette member 52 may be eliminated and the elastomer block 102 may be secured to the surface of the slide 56 in the bottom cassette member 54 using surface energy or surface bonding.

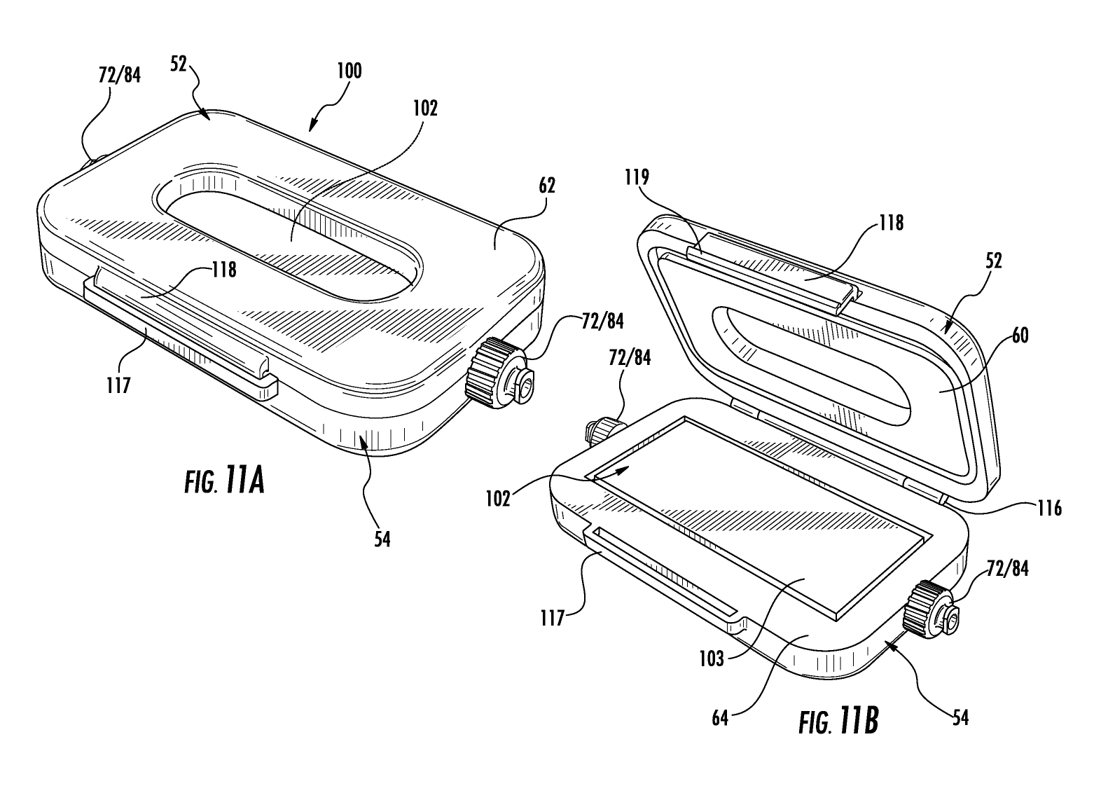

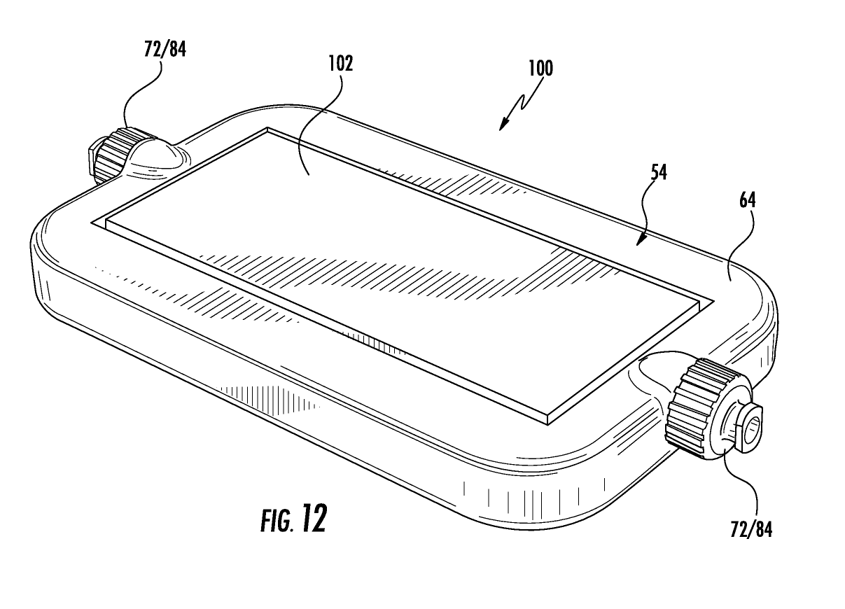

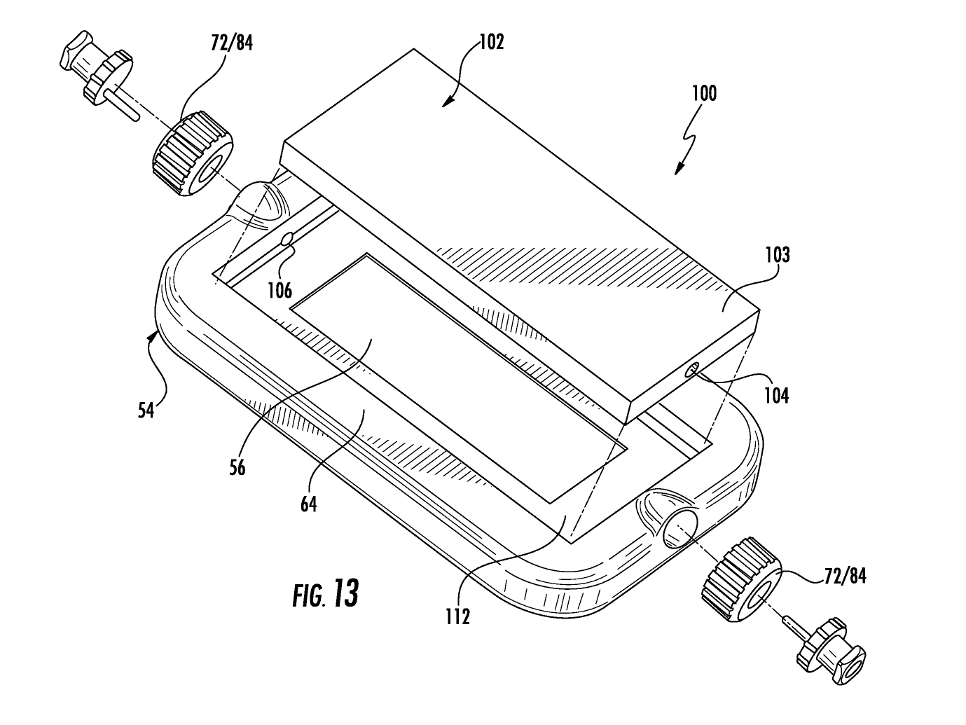

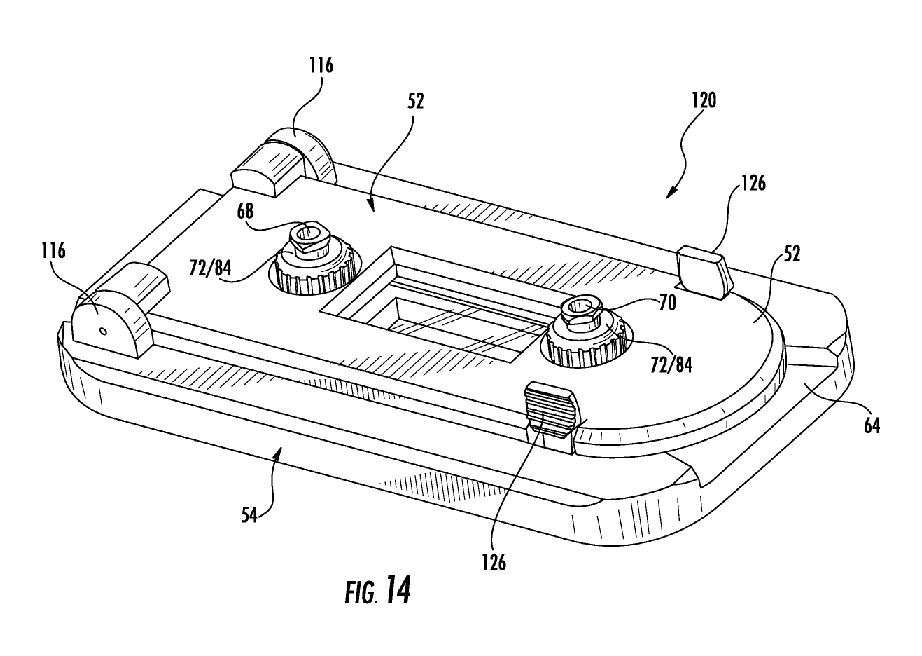

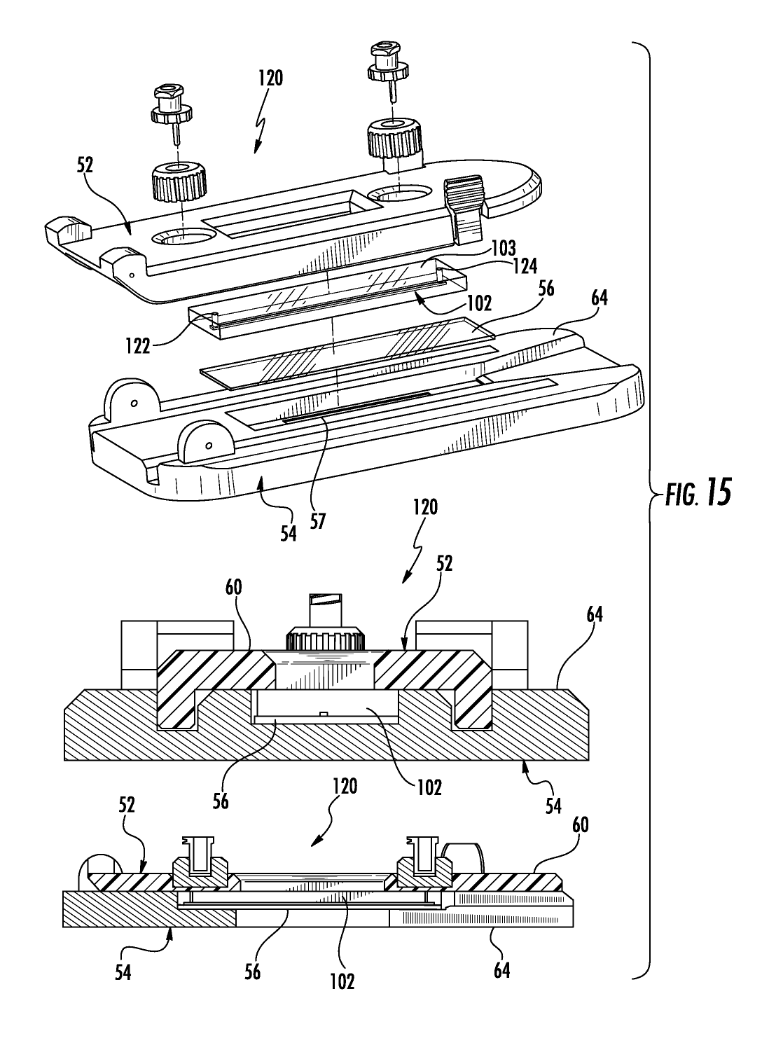

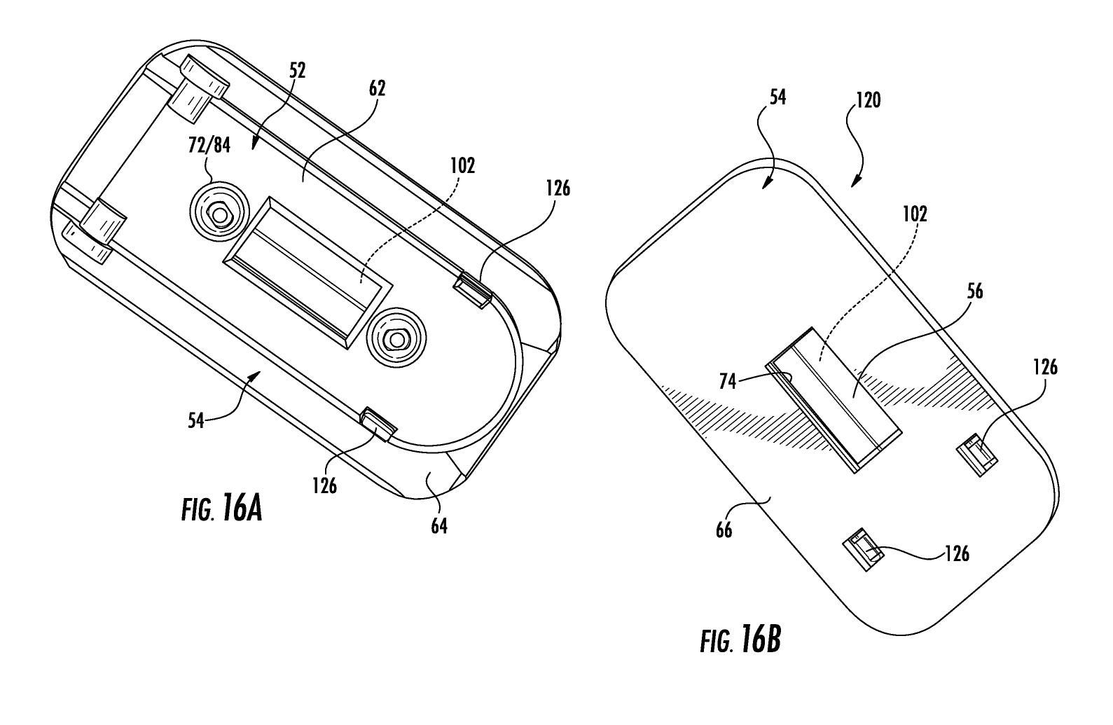

A fourth embodiment of a cell sorting apparatus is shown in FIGS. 14-16B and generally designated at 120. The fourth embodiment of the cell sorting apparatus 120 is substantially similar to the three embodiments described hereinabove. The parts of the fourth embodiment of the sorting apparatus which are identical to those of the sorting apparatus according to the above embodiments are denoted by identical reference numbers and will not be described in detail below. In this embodiment, each end of the top cassette member 52 defines a through bore 122, 124 extending between the outer surface 62 and the inner surface 60. Accordingly, the bores 122, 124 run generally perpendicularly to the axis of the flow channel in the block 102. The bores 122, 124 are internally threaded for receiving luer fittings 72. In use, a syringe or similar device may be used to puncture the elastomer block 102 at an inlet 122 to access the flow channel for delivery of fluid. Openings are provided for visualization of the cells during culturing and the during the flow experiment.

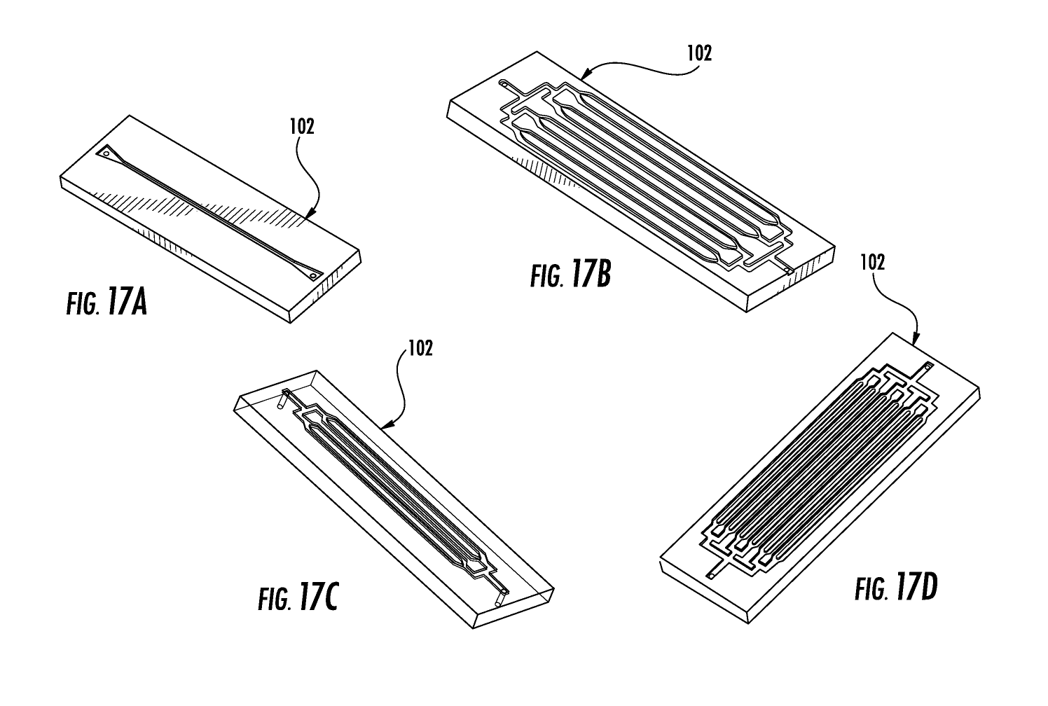

Referring to FIGS. 17A-17D, the elastomer block 102 may have a plurality of flow channels in a range of configurations. One or more of the channels may or may not be interconnected. One inlet channel may be provided or multiple inlet channels. Similarly, one outlet channel may be in fluid communication with at least one branch of the channels. A plurality of outlet channels may also be provided. In some applications, the channels may be non-uniform to create a range of shear stress values simultaneously and capture the outflow of distinct sub-populations of the cultured cells.

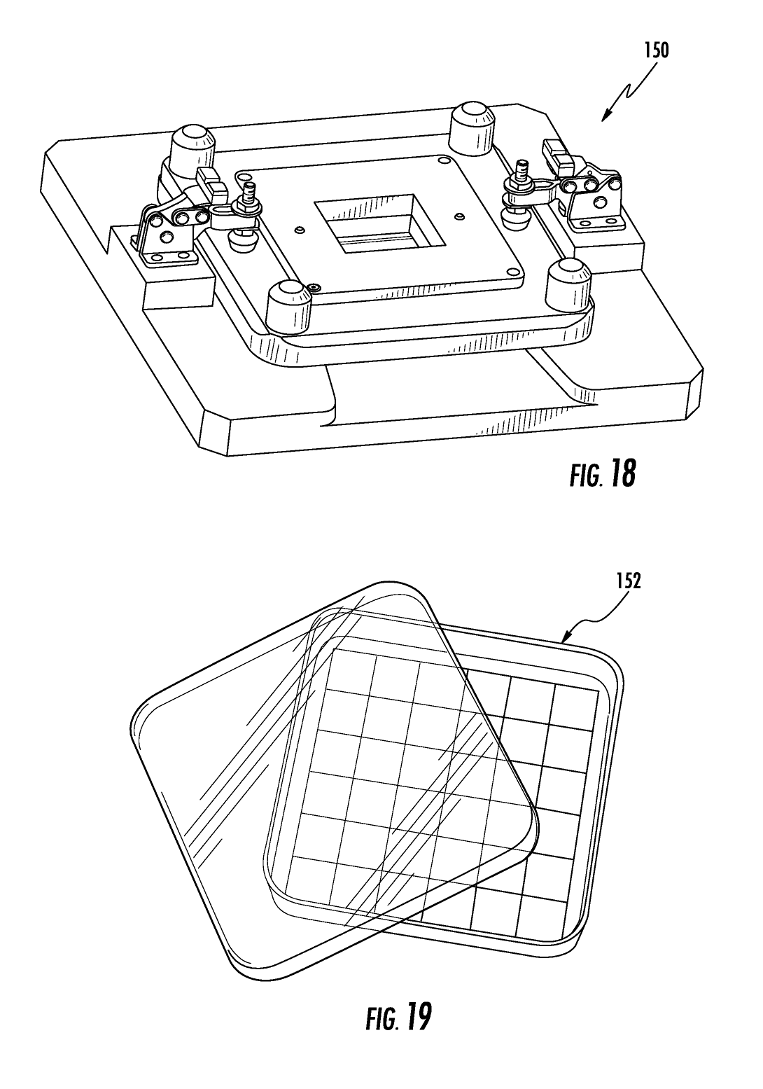

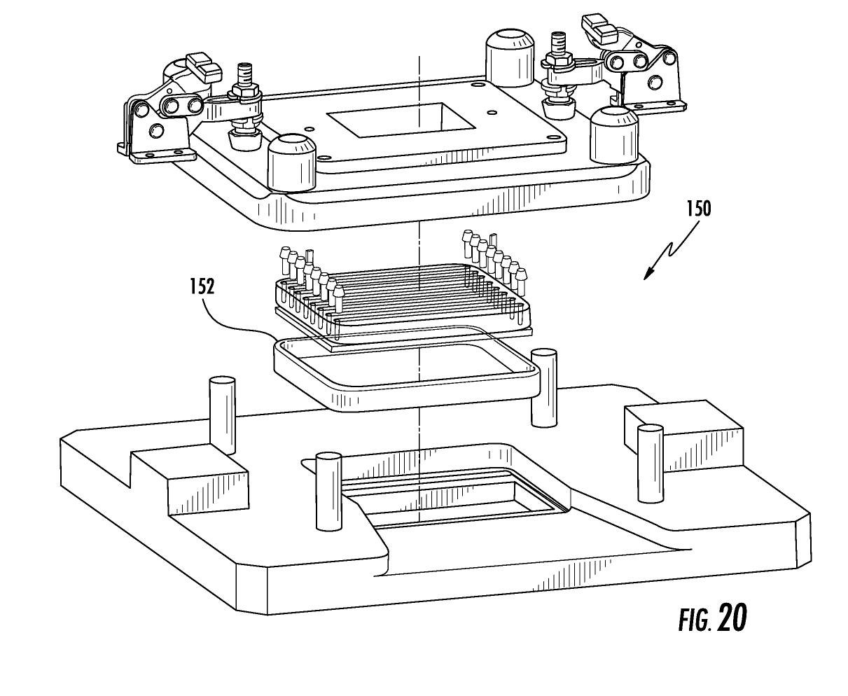

In commercial or otherwise high volume production applications, users are required to process large numbers of cells and may need to sort them multiple times over the course of producing a large number of target cells for delivery in therapeutic applications. The previously described embodiments of the cell sorting apparatus could be used in large numbers and scaled up with increased culture substrate surface area via larger or more numerous flow channels. An embodiment of a cell sorting apparatus suitable for large-scale production is shown in FIGS. 18 and 20 and generally designated at 150. This embodiment of the cell sorting apparatus 150 allows the user to culture large numbers of cells in a conventional cell culture flask or petri dish as shown in FIG. 19 prior to affixing the flow module. In use, the cells are cultured in advance on the cell surface of the dish shown in FIG. 21. Once the cells reach the targeted cell density, the cell culture dish or flask is inserted into the unit as shown in FIG. 20. Clamps are used to compress an elastomeric block having flow channels onto the cell-containing lower surface. Tubing is connected and ready to flow the fluid across the adhered cells at the target shear values needed to isolate the target cell type. The unit is of a large size sufficient to contain a high surface area cell culture surface, such as presented by a tissue culture flask which may feature cell growth areas from: 25 cm² to 1740 cm².

Referring now to FIGS. 21 and 22, a fifth embodiment of an apparatus for sorting cells is shown and generally designated at 180. The fifth embodiment of the cell sorting apparatus 180 is substantially similar to the embodiments described hereinabove. The parts of the fifth embodiment of the sorting apparatus which are identical to those of the sorting apparatus according to the above embodiments are denoted by identical reference numbers and will not be described in detail below. In this embodiment, the top cassette member 52 defines a pair of bores 182, 184 spaced along the central longitudinal axis and opening onto the inner surface 60 of the top cassette member 52. The bores 182, 184 are internally threaded for receiving a microfluidic connectors and seals 84.

The top cassette member 52 and the bottom cassette member 54 of the cell sorting apparatus 180 are configured to be selectively joined together to form the cassette. For this purpose, a plurality of longitudinally spaced holes 186 are provided along each edge of the top cassette member 52. Corresponding threaded openings 188 are provided along the edges of the bottom cassette member 54. Threaded fasteners 190 are used to fasten the top cassette member 52 to the bottom cassette member 54 (FIG. 22). In this arrangement, the gasket 58, after removing a backing 189, is captured between the cassette members 52, 54 for defining a fluid channel from the inlet bore 182 to the outlet bore 184.

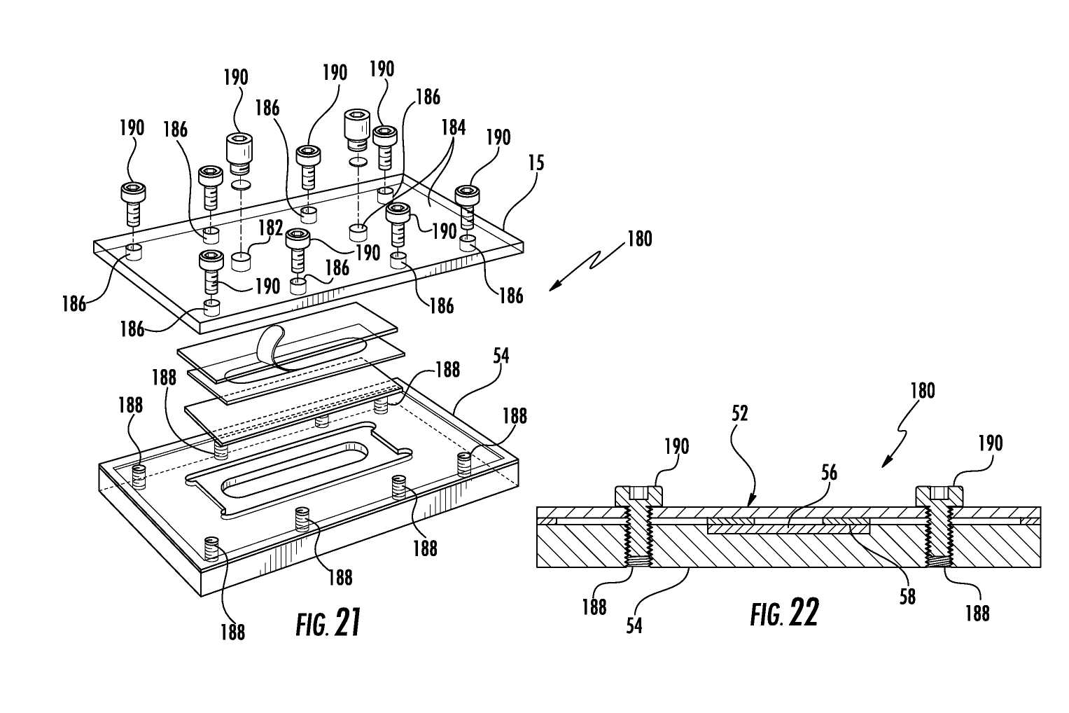

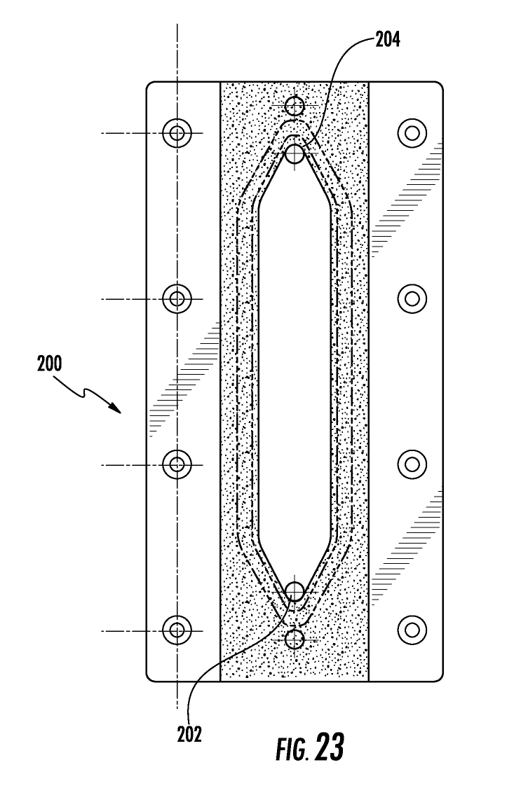

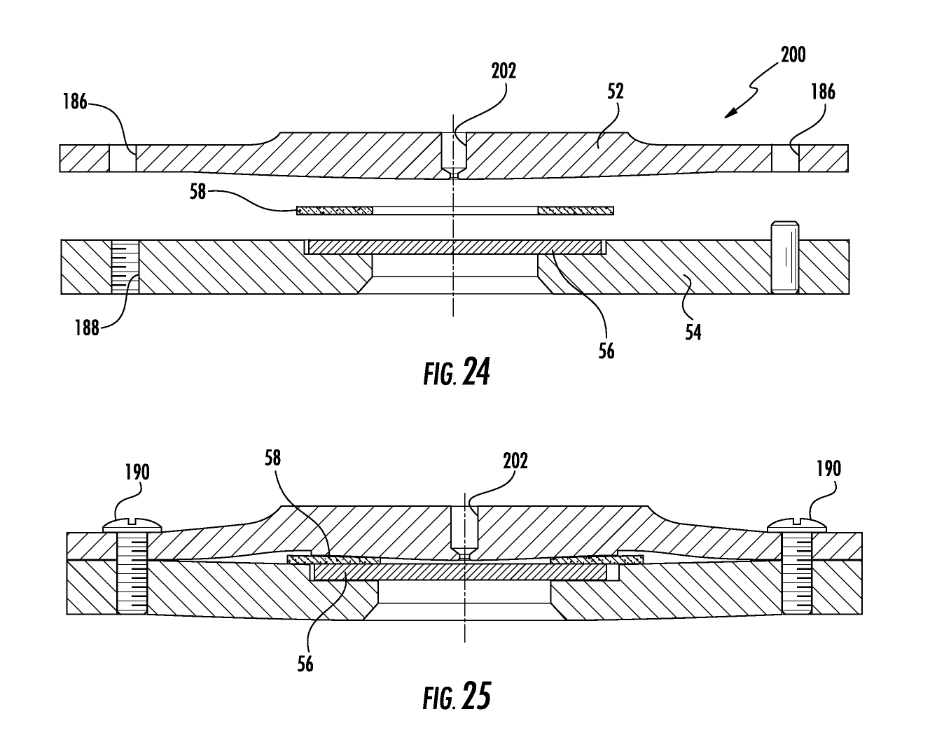

Referring now to FIGS. 23-25, a sixth embodiment of an apparatus for sorting cells is shown and generally designated at 200. The sixth embodiment of the cell sorting apparatus 200 is substantially similar to the embodiments described hereinabove. The parts of the sixth embodiment of the sorting apparatus which are identical to those of the sorting apparatus according to the above-described embodiments are denoted by identical reference numbers and will not be described in detail below. In this embodiment, the top cassette member 52 defines a pair of bores 202, 204 spaced along the central longitudinal axis and opening onto the inner surface 60 of the top cassette member 52. The bores function as an inlet 202 and an outlet 204 for fluid flow thought the cassette. The top cassette member 52 and the bottom cassette member 54 of the cell sorting apparatus 200 are joined together to form the cassette in the same manner as described in the previous embodiment. However, in this embodiment, there is no wall 55 extending upwardly from the periphery of the inner surface 64 of the bottom cassette member 54. When assembled, the longitudinal edges of the top cassette member 52 and the bottom cassette member 54 are drawn together by the threaded fasteners 190 (FIG. 25).

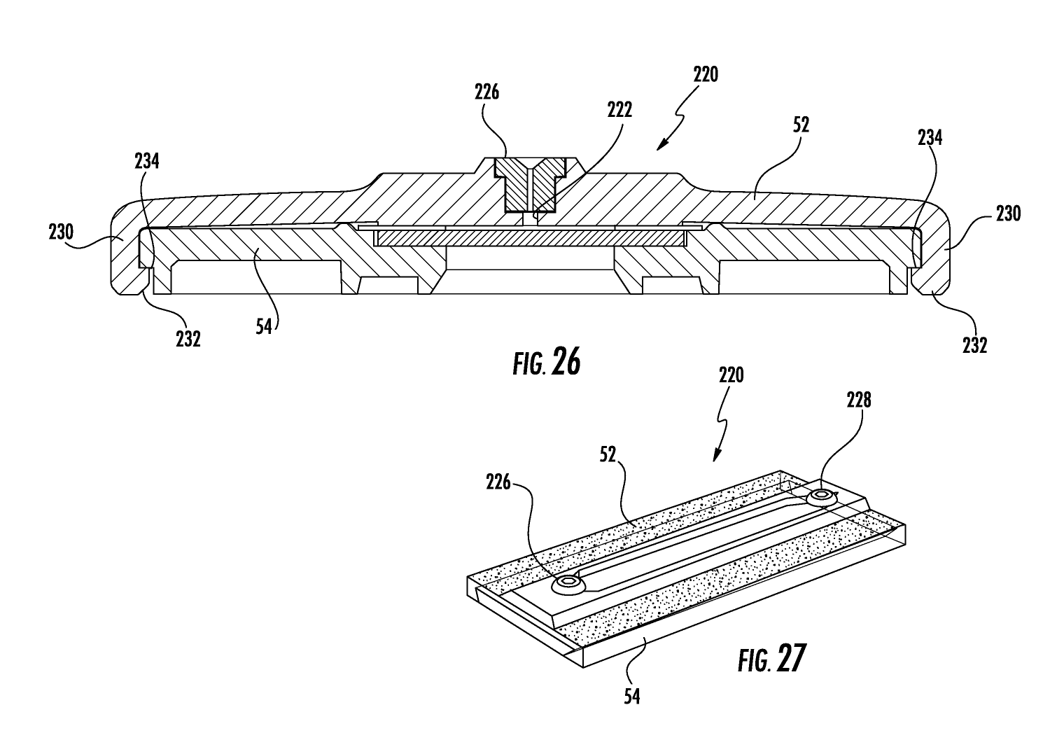

Referring now to FIGS. 26 and 27, a seventh embodiment of an apparatus for sorting cells is shown and generally designated at 220. The seventh embodiment of the cell sorting apparatus 220 is substantially similar to the embodiments described hereinabove. The parts of the seventh embodiment of the cell sorting apparatus which are identical to those of the cell sorting apparatus according to the above-described embodiments are denoted by identical reference numbers and will not be described in detail below. In this embodiment, the top cassette member 52 defines a pair of bores 222, 224 spaced along the central longitudinal axis and opening onto the inner surface 60 of the top cassette member 52. The bores 222, 224 are configured to receive inserts which function as a fluid inlet 226 and a fluid outlet 228 for fluid flow through the cassette.

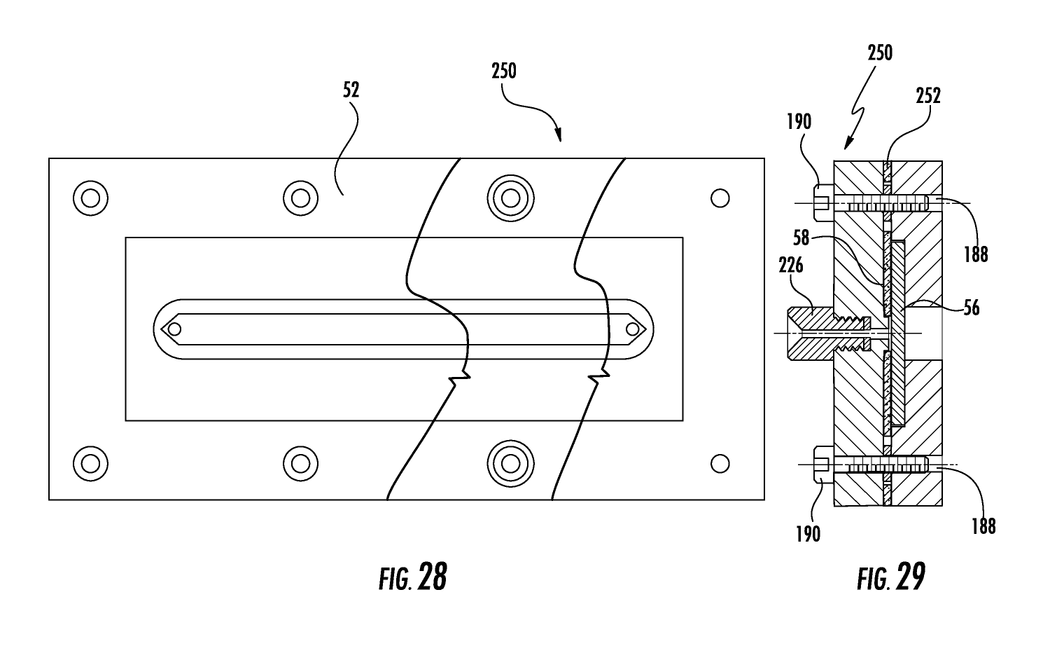

In this embodiment, the top cassette member 52 comprises a continuous depending sidewall 230 terminating in an inwardly extending flange 232 contiguous with the associated sidewall 230. The top cassette member 52 is sized such that the distance between the inner surfaces 231 of the side walls 230 and the distance between the inner surface 60 of the top cassette member 52 and the upper surface 233 of the flanges 232 is slightly larger than width and thickness, respectively, of the bottom cassette member 54. As shown in FIG. 28, the edge of the bottom cassette member 54 is modified for accommodating the top cassette member 52. Specifically, the bottom surface 66 of the bottom cassette member 54 may be modified to add a small countersink or a slot/chamfer 234 to receive the correspondingly configured flange 232 of the top cassette member 52.

The cassette is assembled by sliding the top cassette member 52 over the bottom cassette member 54, as shown in FIG. 29. Alternatively, the size and shape of the top cassette member 52 and integral sidewalls 230 may correspond to the bottom cassette member 54 such that cassette may optionally snap together. The sidewalls 230 are preferably at least slightly resiliently deflectable, which resilience may be easily achieved by proper proportioning of their thickness relative to the projecting distance. Assembling the snap-together cassette 50 begins with bringing the sidewalls 230 of the top cassette member 52 adjacent to the peripheral edges of the bottom cassette member 54. The flange 232 is interlocked with the bottom cassette member 54 by manually urging the flange 232 into the chamfer 234. The sidewalls 230 may be deformable, meaning they may bend or otherwise be altered in shape, to allow the flange 232 to fit past the edges of the bottom cassette member 54 and into the chamfer 234. The sidewalls 230 are also resilient, meaning they will resist deformation and substantially return to their original shape when outside forces are no longer being applied. During insertion, the edge of the bottom cassette member 54 will engage the sidewalls 230 and the flange 232, which will bend slightly outwardly due to manual pressure toward the bottom cassette member 54. Since the sidewalls 230 are resilient, they will resist being compressed outwardly and will, upon the flange 232 clearing the side, resiliently press inwardly on the wall into the chamfer 234. The flange 232 engages the bottom surface 66 of the bottom cassette member 54 that defines the chamfer 234 for securing together the top cassette member 52 and the bottom cassette member 54 (FIG. 29).

With the top cassette member 52 and the bottom cassette member 54 secured together, the gasket 58 is compressed between the inner surface 60 of the top cassette member 52 and the slide 56. The length of the clips 78 and the position of the tabs 80 provides for control of the compressive force on the gasket 58. The opening in the gasket 58 creates a defined flow channel. The openings in the top cassette member 52 receive an inlet fitting 136 and an outlet fitting 138 for introducing and discharging a fluid into and from the channel, such as saline or tissue culture media. The fittings 136, 138 may be provided to attach tubing from the cassette 50 device to a pump (not shown), such as a precision syringe pump.

Referring now to FIGS. 28 and 29, an eighth embodiment of an apparatus for sorting cells is shown and generally designated at 250. The eighth embodiment of the cell sorting apparatus 250 is substantially similar to the embodiments described hereinabove. The parts of the eighth embodiment of the cell sorting apparatus which are identical to those of the cell sorting apparatus according to the above-described embodiments are denoted by identical reference numbers and will not be described in detail below. In this embodiment, an internal silicone gasket 58 is provided as in the previous embodiments. In addition, a peripheral silicone gasket seals the edges of the assembled top cassette member 52 and bottom cassette member 54.

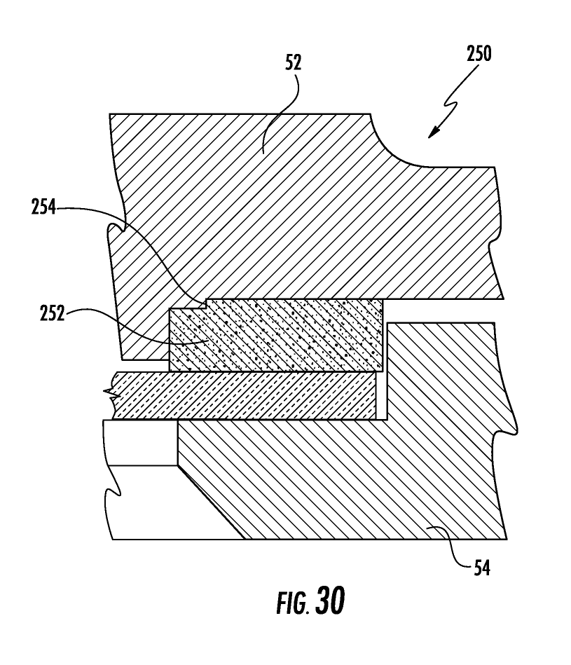

FIG. 30 shows an embodiment of an edge configuration of the top cassette member 52 and the bottom cassette member 54 having a peripheral wall 55 enclosing the silicone gasket 252. In this configuration, the outer edge of the top cassette member 52 includes a step 254 between a depending inner surface 60 and the outer edge of the top cassette member 52. The silicone gasket 252 is wide enough to provide an interference fit with the depending inner surface 60 of the top cassette member 52. When assembled, the step 254 engages the silicone gasket for providing a sealed edge of the cassette.

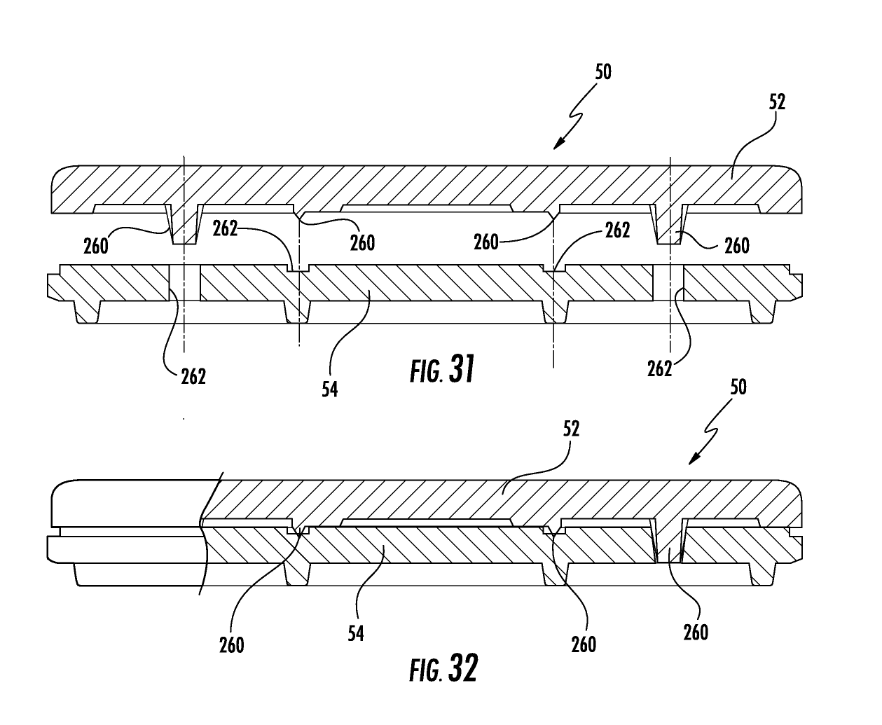

In another embodiment shown in FIGS. 31 and 32, the top caster member 52 and the bottom cassette member 54 may be joined by ultrasonic welding. In this embodiment, the top cassette member 52 includes a plurality of projections 260 extending inwardly toward the bottom cassette member 54. The bottom cassette member 54 has corresponding openings 262 for receiving the projections 260. During assembly, the projections 260 are welded in the openings 262 for forming the cassette 50. Land 264 between the innermost projections of the top cassette member 52 and the fluid channel stop the weld.

Although the cell sorting apparatus has been shown and described in considerable detail with respect to only a few exemplary embodiments thereof, it should be understood by those skilled in the art that I do not intend to limit the cell sorting apparatus to the embodiments since various modifications, omissions and additions may be made to the disclosed embodiments without materially departing from the novel teachings and advantages, particularly in light of the foregoing teachings. For example, the cell sorting apparatus is suitable for use in a number of apparatus and applications for the isolation of stem cells or other cells based on the use of selective detachment force. Accordingly, we intend to cover all such modifications, omission, additions and equivalents as may be included within the spirit and scope of the cell sorting apparatus as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

We claim:

1. A device for use in sorting cells, the cell sorting device comprising:
a first body member having an inner surface and pair of longitudinally spaced through passages opening to the inner surface;
a second body member having an inner surface, a portion of the second body member defining an opening;
a substrate having an inner surface; and
a gasket defining an elongated longitudinal opening,
wherein the first body member is configured to be mounted to the second body member such that the gasket is disposed between the inner surface of the first body member and the substrate, and the substrate is disposed between the gasket and the inner surface of the second body member for overlying the opening in the second body member, and
wherein the openings in the first body member open onto the inner surface of the substrate at opposite ends of a channel defined by the inner surface of the first body member, the gasket and the substrate.

2. A cell sorting device as recited in claim 1, wherein the substrate is transparent.

3. A cell sorting device as recited in 1, wherein the portion of the second body member defining the opening has a continuous ledge for receiving and supporting the substrate such that the inner surface of the substrate is flush with the inner surface of the second body member.

4. A cell sorting device as recited in claim 3, wherein the gasket spaces the inner surface of the first body member from the inner surface of the second body member.

5. A cell sorting device as recited in claim 1, wherein each of the first body member and the second body member comprises a base portion terminating in edges, and further comprising
a continuous peripheral wall depending from the edges of the base portion of one of the first body member or the second body member and terminating in longitudinal edges, and a flange integral with and extending along at least a portion of an edge of the depending wall,
wherein the other of the first body member or the second body member defines a slot along an edge, the slot configured to receive the flange for a snap-fit connecting the first body member and the second body member.

6. A cell sorting device as recited in claim 17, wherein the flange is configured for contacting the other of the first body member and the second body member when connecting for flexing the flange of the first body member resiliently outwardly or resiliently inwardly for changing the outer dimensions of the wall such that the slot defined by the other of the first body member or the second body member receives the terminal edge of the flange.

7. A cell sorting device as recited in claim 6 wherein the terminal edges of the flange of the body portion of one of the first body member or the second body member engage the inner surface of the slot of the other of the first body member or the second body member.

8. A cell sorting device as recited in claim 6 wherein the terminal edges of the flange of the body portion of one of the first body member or the second body member engage the outer surface of the slot of the other of the first body member or the second body member.

9. A cell sorting device as recited in claim 6, wherein the distance from the longitudinal edges of the base portion to the longitudinal edges of the wall is less than the width of the gasket.

10. A cell sorting device as recited in claim 1, wherein each body member comprises a base portion terminating in longitudinal edges, and further comprising legs extending from the longitudinal edges of the base portion of one the first body member or the second body member and terminating in longitudinal edges such that the base portion and the legs define an open longitudinal channel configured to slidably receive the other of the first body member or the second body member.

11. A cell sorting device as recited in claim 7, further comprising a flange integral with and extending along at least a portion of the longitudinal edges of each leg, wherein the other of the first body member or the second body member defines a slot along an edge, the slot configured to receive the flanges for a snap-fit connecting the first body member and the second body member.

12. A cell sorting device as recited in claim 11, wherein the flanges are configured for contacting the other of the first body member or the second body member when connecting for flexing the legs of the first body member or the second body member resiliently outwardly or resiliently inwardly for changing the outer dimensions of the legs such that the slot defined by the other of the first body member or the second body member receives the terminal edges of the flanges.

13. A cell sorting device as recited in claim 11 wherein the terminal edges of the flanges of the body portion of one of the first body member or the second body member engage the inner surface of the slot of the other of the first body member or the second body member.

14. A cell sorting device as recited in claim 11 wherein the terminal edges of the flanges of the body portion of one of the first body member or the second body member engage the outer surface of the slot of the other of the first body member or the second body member.

15. A cell sorting device as recited in claim 11, wherein the distance from the longitudinal edges of the base portion to the longitudinal edges of the legs is less than the width of the gasket.

16. A cell sorting device as recited in claim 1, wherein the each body member comprises a base portion terminating in longitudinal edges, and further comprising legs extending from the longitudinal edges of the base portion of one of the first body member or the second body member and terminating in longitudinal edges, the base portion and the legs defining an open longitudinal channel; and a flange integral with the longitudinal edges of each leg, the flanges extending inwardly such that the base portion, legs, and flanges define opposed longitudinal slots, wherein the longitudinal channel and slots are configured to slidably receive the other of the first body member or the second body member.

17. A cell sorting device as recited in claim 1, further comprising fluid transfer fittings configured to be disposed in the openings in the first body member for communication with a fluid source or fluid capture apparatus.

18. A cell sorting device as recited in claim 1, wherein the first body member is pivotally connected to the second body member for movement between an open position and a closed position where the first body member and the second body member are connected.

19. A device for use for sorting cells, the cell sorting device comprising:
a body member having an inner surface defining a cavity, the first body member having a first end and a second end and holes at each of the first and second ends opening into the cavity;
a block member having an outer surface defining a longitudinally extending open channel; and
a substrate,
wherein the block member is configured to be disposed in the body member such that the first and second holes align with the ends of the channel and the substrate is disposed between the inner surface of the body member and the block member.

20. The cell sorting device as recited in claim 19, wherein a portion of the body member defining the cavity has an opening, wherein the substrate overlies the opening in the body member.

21. The cell sorting device as recited in 20, wherein the portion of the body member defining the opening has a continuous ledge for receiving and supporting the substrate such that the inner surface of the substrate is flush with the inner surface of the body member.

22. The cell sorting device as recited in claim 20, wherein the channel in the block member opens onto the surface of the substrate.

23. A device for use in sorting cells, the cell sorting device comprising:
a first body member having an inner surface;
a second body member having an inner surface defining a cavity, the second body member having a first end and a second end and holes at each of the first and second ends opening into the cavity;
a block member having a longitudinally extending channel; and
a substrate having an inner surface,
wherein the first body member is configured to be mounted to the second body member such that the block member is disposed in the cavity between the inner surface of the first body member and the inner surface of the substrate, and the substrate is disposed between the block member and the inner surface of the second body member, and
wherein the block member is configured to be disposed in the cavity such that the first and second holes align with the ends of the channel.

24. The cell sorting device as recited in claim 23, wherein a portion of the second body member defining the cavity has an opening, wherein the substrate overlies the opening in the body member.

25. The cell sorting device as recited in 24, wherein the portion of the body member defining the opening has a continuous ledge for receiving and supporting the substrate.
